(19) United States
(12) Patent Application Publication
(10) Pub. No.: US 2017/0045369 A1
(43) Pub. Date: Feb. 16, 2017

(54) APPARATUS AND METHOD FOR CONTROLLING VEHICLE PARKING

(71) Applicant: HYUNDAI MOTOR COMPANY, Seoul (KR)

(72) Inventors: Sung Yun KIM, Seoul (KR); Min Wook SEO, Suwon-si (KR); Joo Woong YANG, Seoul (KR); Jun Soo KIM, Seoul (KR); Dong Hun YANG, Anyang-si (KR); Kyung Soo HA, Pohang-si (KR); Bong Chul KO, Hwaseong-si (KR); Gil Won SEO, Hwaseong-si (KR)

(21) Appl. No.: 14/957,472

(22) Filed: Dec. 2, 2015

(30) Foreign Application Priority Data
Aug. 10, 2015 (KR) 10-2015-0112339

(51) Int. Cl. G01C 21/36

(52) U.S. Cl. CPC G01C 21/362; G01C 21/3617

(57) ABSTRACT

An apparatus for controlling parking of a vehicle includes a destination setter for setting a destination required by a user and setting search information on a parking space in a vicinity of the set destination, a controller for registering information on the empty parking space in the vicinity of the destination received from the outside when the vehicle arrives in a defined distance from the point set to the destination, and a parking guider for performing parking guidance so that the registered empty parking space becomes a final destination.

### CROSS-REFERENCE TO RELATED APPLICATION

This application is claims the benefit of priority to Korean Patent Application No. 10-2015-0112339, filed on Aug. 10, 2015 with the Korean Intellectual Property Office, the disclosure of which is incorporated herein in its entirety by reference.

### TECHNICAL FIELD

The present disclosure relates to an apparatus and a method for controlling parking of a vehicle.

### BACKGROUND

Recently, as the number and scale of parking lots has increased in accordance with a significant increase in a penetration rate of vehicles and a utilization rate of vehicles, a time required for parking vehicles has increased.

An infrastructure providing parking space information has been developed in department stores, large discount stores, or the like, to provide information on empty parking spaces to a vehicle driver. However, the vehicle driver may still not avoid searching for an empty parking space in which he/she may park the vehicle, and it is more difficult to search for an empty parking space in a place where the infrastructure providing the parking space information is not employed.

### SUMMARY OF THE DISCLOSURE

The present disclosure has been made to solve the above-mentioned problems occurring in the prior art while advantages achieved by the prior art are maintained intact.

An aspect of the present disclosure provides an apparatus and a method for controlling parking of a vehicle capable of allowing a parking position to be rapidly determined by receiving information on an empty parking space in the vicinity of a destination from the preceding vehicle driven in the vicinity of the destination.

According to an exemplary embodiment of the present disclosure, an apparatus for controlling parking of a vehicle includes: a destination setter configured to set a destination required by a user and set search information on a parking space in the vicinity of the set destination, a controller configured to register information on an empty parking space in the vicinity of the destination received from the outside when the vehicle arrives in a defined distance from the point set to the destination and a parking guider configured to perform parking guidance so that the registered empty parking space becomes a final destination.

The information on the empty parking space in the vicinity of the destination may be received from a preceding vehicle connected in a vehicle to vehicle (V2V) communication scheme and driven at the point set to the destination.

The information on the empty parking space in the vicinity of the destination may be received from a server connected in a vehicle to infrastructure (V2I) communication scheme and managing an occupancy state of the parking space.

The information on the empty parking space in the vicinity of the destination may be provided by the server registering occupancy state information on the parking space of the point set to the destination provided from one or more preceding vehicles driven at the point set to the destination.

The information on the empty parking space in the vicinity of the destination may be recognized at the front, the rear, the left, or the right of a point through which one or more preceding vehicles driven at the point set to the destination pass by sensors provided in the one or more preceding vehicles.

The information on the empty parking space in the vicinity of the destination may include one or more of position information, path information, and reliability information on the corresponding empty parking space.

The search information on the parking space in the vicinity of the destination may include at least one of whether or not the parking space in the vicinity of the destination is searched, a parking space search allowance distance, and parking space preferring information.

The parking guider may determine the final destination on the basis of preset parking space search information among the registered empty parking spaces.

The parking guider may determine the final destination except for empty parking spaces on which occupancy notifying information is received when the occupancy notifying information on at least one the registered empty parking spaces is received from the outside.

The controller may allow occupancy determination information on the corresponding empty parking space to be transmitted to the outside when the final destination is determined by the parking guider.

According to another exemplary embodiment of the present disclosure, a method for controlling parking of a vehicle includes: setting a destination required by a user and setting search information on a parking space in the vicinity of the set destination, receiving information on an empty parking space in the vicinity of the destination from the outside when the vehicle arrives in a defined distance from a point set to the destination, registering the received information on the empty parking space in the vicinity of the destination and performing parking guidance so that the registered empty parking space becomes a final destination.

In the receiving of the information on the empty parking space in the vicinity of the destination, the information on the empty parking space in the vicinity of the destination may be received from a preceding vehicle connected in a V2V communication scheme and driven at the point set to the destination.

In the receiving of the information on the empty parking space in the vicinity of the destination, the information on the empty parking space in the vicinity of the destination may be received from a server connected in a V2I communication scheme and managing an occupancy state of the parking space.

The performing of the parking guidance may include determining the final destination on the basis of preset parking space search information among the registered empty parking spaces.

In the determining of the final destination, the final destination may be determined except for empty parking spaces on which occupancy notifying information is received when the occupancy notifying information on at least on the empty parking spaces is received from the outside.

The method may further include transmitting occupancy determination information on the corresponding empty parking space to the outside when the final destination is determined.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating a configuration of a system to which an apparatus for controlling parking of a vehicle according to an exemplary embodiment of the present disclosure is applied.

FIG. 2 is a view illustrating a detailed configuration of a server of FIG. 1.

FIG. 3 is a view illustrating a detailed configuration of a preceeding vehicle of FIG. 1.

FIG. 4 is a view illustrating a detailed configuration of a target vehicle of FIG. 1.

FIGS. 5A to 5C are views illustrating an example of an operation of the apparatus for controlling parking of a vehicle according to an exemplary embodiment of the present disclosure.

FIG. 6 is a view illustrating an example of an empty parking space operation of a preceding vehicle according to an exemplary embodiment of the present disclosure.

FIGS. 7A to 7D are views illustrating a structure of a message transmitted to and received from the apparatus for controlling parking of a vehicle according an exemplary embodiment of the present disclosure.

FIGS. 8 to 10 are views illustrating a flow of operations of a method for controlling parking of a vehicle according to an exemplary embodiment of the present disclosure.

### DETAILED DESCRIPTION

It is to be noted that technical terms used in the present disclosure are used in order to describe specific exemplary embodiments and do not limit the present disclosure. In addition, unless indicated otherwise in the present disclosure, it is to be understood that all the technical terms used in the present disclosure are construed as meaning as those that are generally understood by those who skilled in the art rather than as excessively comprehensive meaning and excessively reduced meaning. In addition, when the technical terms used in the present disclosure are wrongly technical terms that do not accurately indicate the technical spirit of the present disclosure, it is to be understood that the terms are replaced with the technical terms understood by those skilled in the art. Further, the general terms used in the present disclosure must be understood according to the terms defined by the dictionary or the context and should not be excessively reduced meanings.

In addition, singular forms used in the present disclosure are intended to include plural forms unless the context clearly indicates otherwise. In the present disclosure, it is to be noted that the terms “configured of”, “including’, or the like, are not to be construed as necessarily including several components or several steps described in the present disclosure and some of the above components or steps may not be included or additional components or steps are construed as being further included.

In addition, terms including an ordinal number such as first, second, or the like, used in the present disclosure may be used to describe various components. However, these components are not limited to these terms. Terms are used only in order to distinguish one component from another component. For example, the ‘first’ component may be named the ‘second’ component, and vice versa, without departing from the scope of the present disclosure.

Hereinafter, exemplary embodiments of the present disclosure will be described in more detail with reference to the accompanying drawings. The same reference numerals will be used to describe the same or like components, independent of the reference numerals and an overlapped description of the same components will be omitted.

Further, when it is decided that the detailed description of the known art related to the present disclosure may obscure the meaning of the present disclosure, the detailed description thereof will be omitted. In addition, it is to be noted that the accompanying drawings are provided only in order to allow the spirit of the present disclosure to be easily understood and is not to be interpreted as limiting the spirit of the present disclosure.

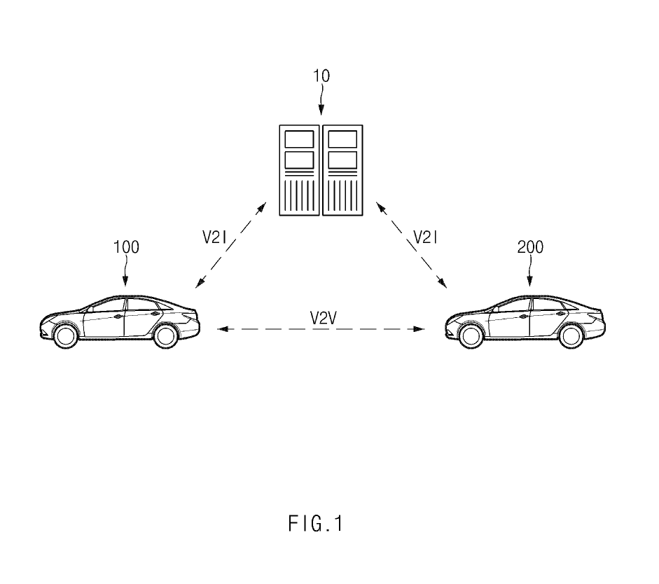

FIG. 1 is a view illustrating a configuration of a system to which an apparatus for controlling parking of a vehicle according to an exemplary embodiment of the present disclosure is applied.

Referring to FIG. 1, the system according to an exemplary embodiment of the present disclosure may include an apparatus for controlling parking of a vehicle and further include a server 10 and a preceding vehicle 100.

The server 10 may build-up and manage a parking space map database (DB) 13 and manage occupancy states of parking spaces corresponding to the parking space map DB 13. The server 10 may provide the parking space map DB 13 to the preceding vehicle 100 and/or a target vehicle 200.

On the other hand, the server 10 may not build-up a parking space map DB separately. In this case, the server 10 may receive location information of parking spaces for the preceding vehicle 100, such as an absolute coordinate, then may provide information of the parking space based on the received coordinate information. However, in the embodiment below will be described a technique for providing information of the parking space on the basis of the parking space map DB.

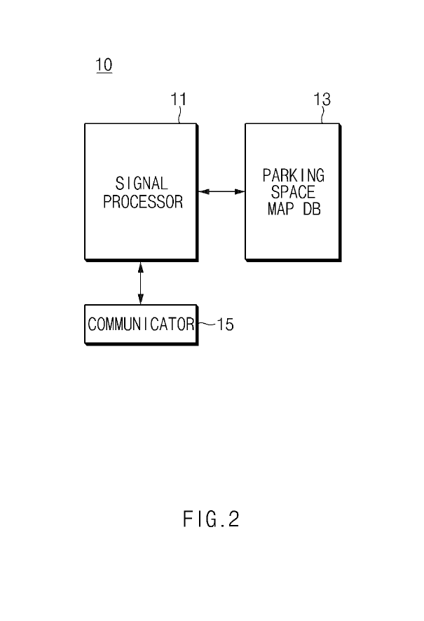

Here, a detailed configuration of the server 10 will be described with reference to FIG. 2.

Referring to FIG. 2, the server 10 may include a signal processor 11, the parking space map DB 13, and a communicator 15.

The signal processor 11 may register information of the preceding vehicle 100 providing occupancy information on a parking space in the vicinity of a destination, receive search information on the parking space in real time from the preceding vehicle 100, and reflect the received search information in the parking space map DB 13.

In addition, the signal processor 11 may provide information on an empty parking space in the vicinity of the destination defined by the target vehicle 200 on the basis of the search information on the parking space provided from the preceding vehicle 100 in the case in which a search request for the parking space from the target vehicle 200 is present. When it is confirmed that the empty parking space is occupied by another vehicle after the information on the empty parking space is provided, the signal processor 11 may provide occupancy notifying information on the corresponding empty parking space to the target vehicle 200 and other target vehicles positioned in the vicinity of the target vehicle 200.

The parking space map DB 13 stores map data on a plurality of parking spaces therein. The parking space map DB 13 may update the search information on the parking space provided from the preceding vehicle 100.

The communicator 15 may transmit and receive signals to and from the preceding vehicle 100 and/or the target vehicle 200. Here, the communicator 15 serves to transmit signals generated by the signal processor 11 to the preceding vehicle 100 or the target vehicle 200 and receive and transfer signals transmitted from the preceding vehicle 100 and/or the target vehicle 200.

As an example, the communicator 15 may transmit a signal for requesting the search information on the parking space from the signal processor 11 to the preceding vehicle 100, and receive a response signal from the preceding vehicle 100. The communicator 15 may also receive information transmitted in real time from the preceding vehicle 100. In addition, the communicator 15 may receive a signal for requesting information on an empty parking space from the target vehicle 200, and transmit the information on the empty parking space corresponding to the request of the target vehicle 200 to the target vehicle 200.

The communicator 15 may include a module supporting wireless Internet access. Here, an example of the wireless Internet technology may include wireless local area network (WLAN), wireless broadband (Wibro), Wi-Fi, world interoperability for microwave access (Wimax), high speed downlink packet access (HSDPA), and the like.

The preceding vehicle 100, which is a vehicle driven to a point set to a destination, may be one or more vehicles that are registered in advance. The preceding vehicle 100 searches the empty parking space in the vicinity of the destination and provides the search information on the parking space to the server 10 or the target vehicle 200 arriving in a defined distance from the point set to the destination.

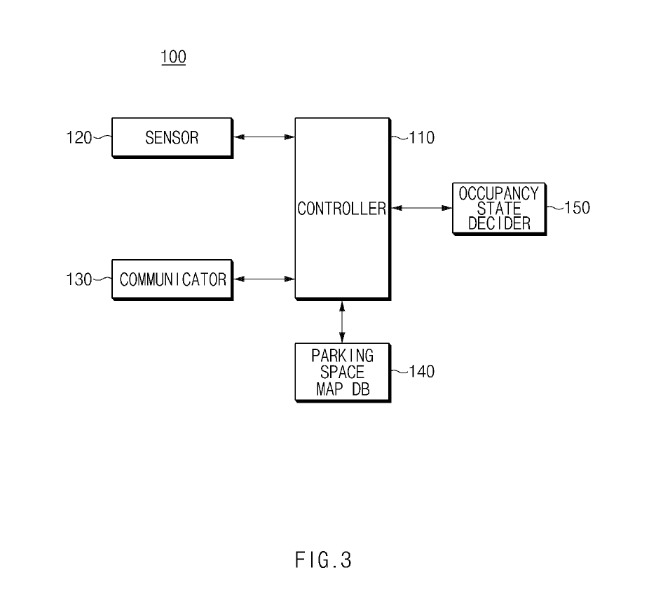

Here, a detailed configuration of the preceding vehicle 100 will be described with reference to FIG. 3.

Referring to FIG. 3, the preceding vehicle 100 may include a controller 110, a sensor 120, a communicator 130, a parking space map DB 140, and an occupancy-state decider 150. Here, the controller 110 may process operations of the respective units of the preceding vehicle 100 and process signals transferred between the respective units.

The sensor 120 serves to search a parking space positioned in the vicinity of the preceding vehicle 100 during a period in which the vehicle is driven in the vicinity of the destination. An example of an operation of searching the parking space with the sensor 120 will be described with reference to FIG. 6. As illustrated in FIG. 6, the sensor 120 may search a front, rear, left, or right parking space of a point through which the preceding vehicle 100 passes using sensors provided in the preceding vehicle 100.

As an example, the sensor 120 may sense the parking space and sense a vehicle parked in the parking space. In addition, the sensor 120 may sense positions of other parked vehicles in the case in which the parking space is not present or available. In this case, the sensor 120 may transfer search information on the parking space to the occupancy state decider 150 through the controller 110.

Here, the sensor 120 may include a laser scanner, an audio video monitor (AVM), an ultrasonic radar, and the like, and sensors having different forms may be applied according to exemplary embodiments.

The communicator 130 may include a communication module for transmitting and receiving signals to and from the server 10 or the target vehicle 200. Here, the communication module may include a first module supporting vehicle to infrastructure (V2I) communication with the server 10 and a second module supporting vehicle to vehicle (V2V) communication with the target vehicle 200. Here, the first module may perform communication with a roadside equipment through the V2I communication and may access the server 10 through the roadside equipment with which the communication is connected.

The occupancy state decider 150 may detect an empty parking space on the basis of the search information on the parking space from the sensor 120.

Here, when a vehicle is not sensed in a region in which the parking space is sensed by the sensor 120, the occupancy state decider 150 may decide that the corresponding region is the empty parking space. In addition, the occupancy state decider 150 may also detect the empty parking space on the basis of parking patterns of other vehicles sensed by the sensor 120 in a region in which the parking space is not sensed.

The controller 110 may provide the search information on the parking space including information on the region recognized as the empty parking space by the occupancy state decider 150 to the server 10 or the target vehicle 200 through the communicator 130. In this case, the controller 110 may also match a position of the region recognized as the empty parking space to the parking space map DB 140 and provide information matched to the parking space map DB 140 to the server 10 or the target vehicle 200.

As an example, in the case in which the target vehicle 200 arrives at a defined distance from the point set to the destination, the controller 110 may provide the search information on the parking space directly to the target vehicle 200. Here, the controller 110 may preferentially provide the search information on the parking space to any one target vehicle 200 selected in consideration of preset conditions, for example, an arrival distance, an arrival time, and the like, in the case in which the number of target vehicles 200 is plural.

The parking space map DB 140 is a means by which parking space map information provided from the server 10 is stored, and when the empty parking space is recognized by the occupancy state decider 150, the controller 110 may also register information on the recognized empty parking space to a corresponding position on a parking space map.

Meanwhile, the occupancy state decider 150 may recognize that the recognized empty parking space is changed into a state in which it is occupied by another vehicle on the basis of information sensed by the sensor 120. In this case, the controller 110 may generate occupancy notifying information on the corresponding empty parking space and provide the occupancy notifying information to the server 10 or the target vehicle 200 through the communicator 130.

The apparatus for controlling vehicle parking may receive the information on the empty parking space from the server 10 or the preceding vehicle 100 and guide parking so that the corresponding empty parking space becomes a final destination.

Here, the apparatus for controlling parking of a vehicle may be a separate apparatus provided in the target vehicle 200 or the apparatus for controlling parking of a vehicle may be the target vehicle 200. Hereinafter, an exemplary embodiment of the present disclosure will be described under the assumption that the apparatus for controlling parking of a vehicle is the target vehicle 200.

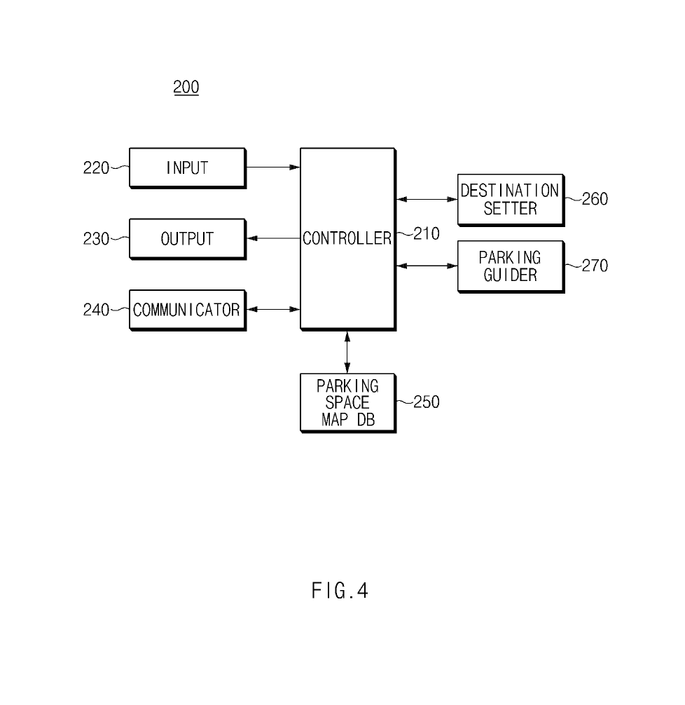

Therefore, a detailed configuration of the target vehicle 200 will be described with reference to FIG. 4.

Referring to FIG. 4, the target vehicle 200 may include a controller 210, an input 220, an output 230, a communicator 240, a parking space map DB 250, a destination setter 260, and a parking guider 270.

The input 220, which is a mean for receiving a control command input from a user, may be a key button provided in an instrument panel of the target vehicle 200 or a soft key implemented on a display provided on the target vehicle 200. In addition, the input 220 may be a button implemented on a navigation device of the target vehicle. The input 220 may be an input means such as a mouse, a joy stick, a jog shuttle, or a stylus pen.

The output 230 may include a display on which state information and guide information on an operation for controlling parking of the target vehicle 200, map information registered in the parking space map DB 250, and the like, are displayed, and may include a speaker for producing guiding corresponding information as a sound.

Here, in the case in which the display includes a sensor sensing a touch operation, the display may be used as an input apparatus as well as an output apparatus. That is, in the case in which a touch sensor such as a touch film, a touch sheet, a touch pad, or the like, is provided in the display, the display may be operated as a touch screen and be implemented in a form in which the input 220 and the output 230 are integrated with each other.

Here, the display may include at least one of a liquid crystal display (LCD), a thin film transistor-liquid crystal display (TFT LCD), an organic light-emitting diode (OLED), a flexible display, a field emission display (FED), and a 3D Display.

The communicator 240 may include a communication module for transmitting and receiving signals to and from the server 10 or the preceding vehicle 100. Here, the communication module may include a first module supporting V2I communication with the server 10 and a second module supporting V2V communication with the preceding vehicle 100. Here, the first module may perform communication with roadside equipment through the V2I communication and may access the server 10 through the roadside equipment with which the communication is connected.

The parking space map DB 250 is a means by which the parking space map information provided from the server 10 is stored. When the information on the empty parking space is received from the server 10 or the preceding vehicle 100, the controller 210 may register the received information on the empty parking space to a corresponding position on the parking space map.

In addition, when a destination is set by the destination setter 260, the parking space map DB 250 may provide a parking space map corresponding to the set destination through the display. Further, in the case in which parking guidance to the final destination is performed by the parking guider 270, the parking space map DB 250 may provide map information corresponding to a parking guiding path up to the final destination through the display.

The destination setter 260 may allow the destination input from the user through the input 220 to be set at the time of driving the target vehicle 200. Here, the destination may be a destination of the navigation device.

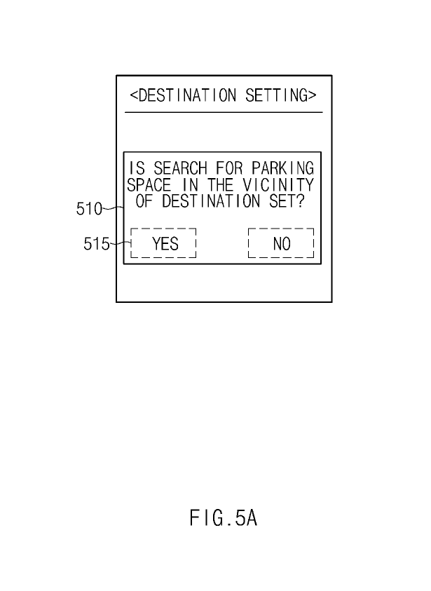

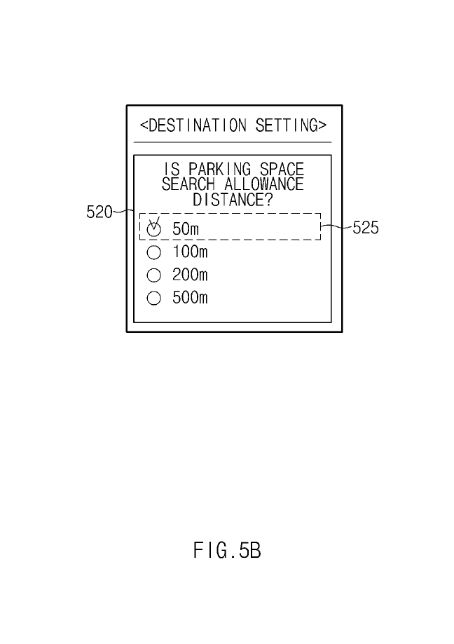

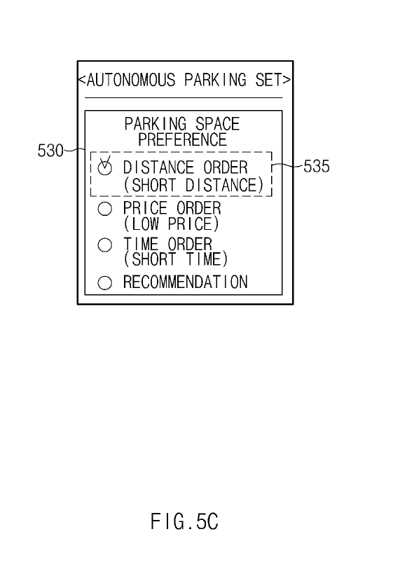

In addition, the destination setter 260 may set the search information on the parking space input from the user at the time of setting the destination. As an example, the search information on the parking space may be whether or not a parking space in the vicinity of the destination is searched, a parking space search allowance distance, parking space preferring information, and the like. An example of an operation of setting the search information on the parking space will be described with reference to FIGS. 5A to 5C.

In other words, the destination setter 260 may set whether or not the parking space in the vicinity of the destination is searched through a parking space search setting screen 510 at the time of setting the destination, as illustrated in FIG. 5A.

In the case in which it is set that the parking space in the vicinity of the destination is searched, the destination setter 260 may set the search information on the parking space through an item 525 selected in a parking space search allowance distance setting screen 520 illustrated in FIG. 5B and an item 535 selected in a parking space preference setting screen 530 illustrated in FIG. 5C. Naturally, the search information on the parking space may be added, modified, or deleted according to exemplary embodiments.

In the case in which it is set by the destination setter 260 that the parking space in the vicinity of the destination is searched, the controller 210 may request the server 10 managing an occupancy state of the corresponding parking space or the preceding vehicle 100 driven at the point set as the destination to transmit search information on the parking space in the vicinity of the destination when the target vehicle 200 arrives at a defined distance from the point set to the destination.

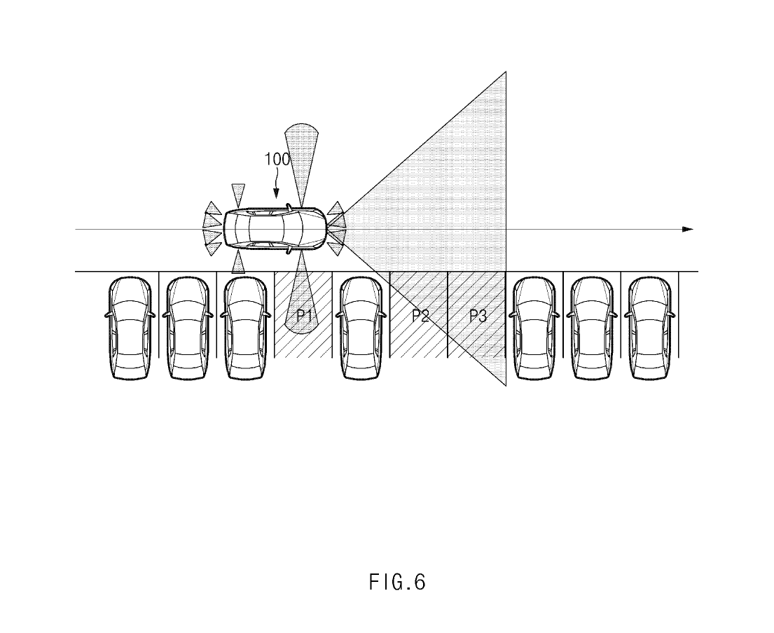

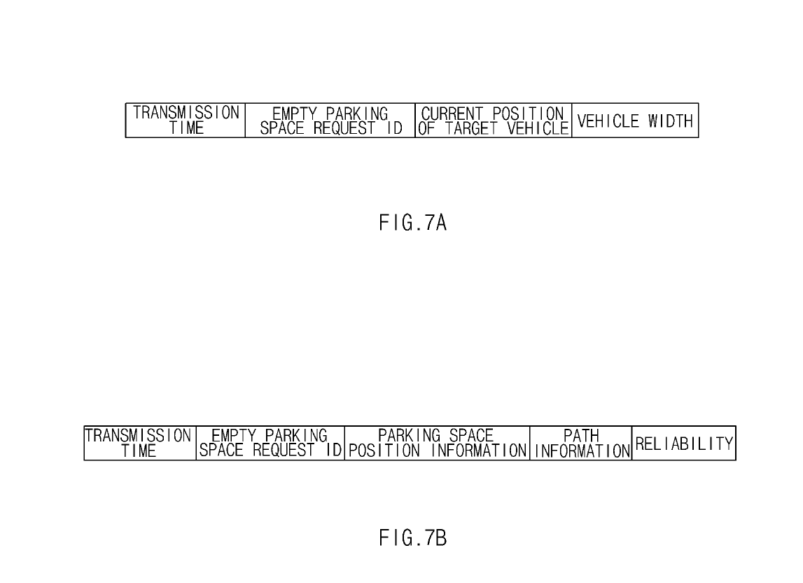

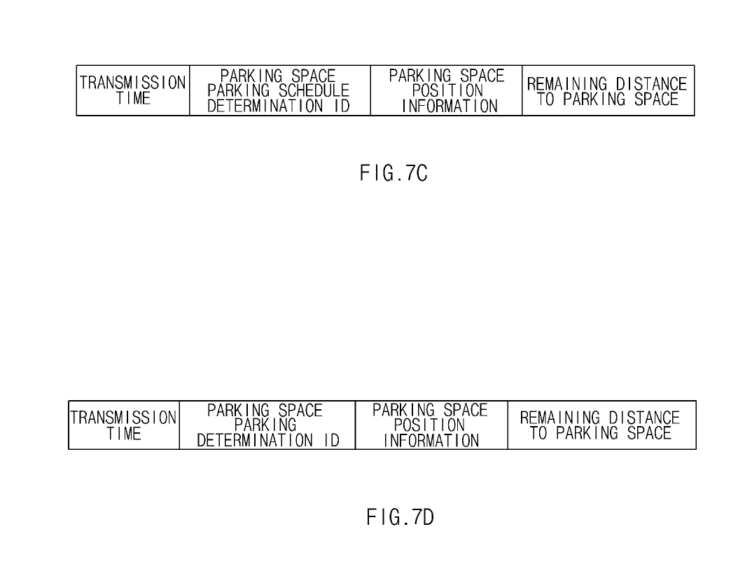

A structure of a message for requesting the server 10 or the preceding vehicle 100 to transmit the search information on the parking space in the vicinity of the destination may be represented as illustrated in FIG. 7A. As illustrated in FIG. 7A, the message for requesting the search information on the parking space may include one or more of a message transmission time from the target vehicle 200, an empty parking space request ID, a current position of the target vehicle 200, and a vehicle width of the target vehicle 200.

Here, when the search information on the parking space in the vicinity of the destination, that is, information on the empty parking space is received from the server 10 or the preceding vehicle 100, the controller 210 registers the received information on the empty parking space in the parking space map DB 250.

A structure of a message including the search information on the parking space in the vicinity of the destination received from the server 10 or the preceding vehicle 100 may be represented as illustrated in FIG. 7B. As illustrated in FIG. 7B, the message including the search information on the parking space may include one or more of a message transmission time from the server 10 or the preceding vehicle 100, an empty parking space notifying ID, parking space position information, path information, and reliability information.

The parking guider 270 may perform parking guidance for the target vehicle 200 so that the empty parking space registered in the parking space map DB 250 becomes a final destination.

In the case in which the number of empty parking spaces registered in the parking space map DB 250 is plural, the parking guider 270 may reflect preset parking space search information, for example, a parking space search allowance distance and parking space preferring information to determine that an empty parking space satisfying conditions is a final destination.

Meanwhile, the communicator 240 may receive occupancy notifying information on the empty parking space registered in the parking space map DB 250 from the server 10 or the preceding vehicle 100. In this case, the parking guider 270 may determine a final destination other than the empty parking space on which the occupancy notifying information is received.

In addition, the parking guider 270 may provide occupancy determination information on the empty parking space corresponding to the final destination to the server 10 or the preceding vehicle 100.

As an example, the parking guider 270 may provide the occupancy determination information to the server 10 or the preceding vehicle 100 when the target vehicle 200 arrives at a defined distance from the empty parking space. As another example, the parking guider 270 may also provide the occupancy determination information on the corresponding empty parking space to the server 10 or the preceding vehicle 100 when the target vehicle 200 is attempted to be parked in the empty parking space corresponding to the final destination.

Here, a structure of a message including the occupancy determination information on the empty parking space may be represented as illustrated in FIG. 7C. As illustrated in FIG. 7C, the message including the occupancy determination information on the empty parking space may include one or more of a message transmission time from the target vehicle 200, a parking space parking schedule determination ID, parking space position information, and a remaining distance to the parking space.

As described above, when occupancy of the empty parking space by the target vehicle 200 is determined, the server 10 or the preceding vehicle 100 may provide occupancy notifying information on the corresponding empty parking space to other target vehicles positioned in the vicinity of the destination.

Here, a structure of a message including the occupancy notifying information on the empty parking space may be represented as illustrated in FIG. 7D. As illustrated in FIG. 7D, the message including the occupancy notifying information on the empty parking space may include one or more of a message transmission time from the server 10 or the preceding vehicle 100, a parking space parking determination ID, parking space position information, and a remaining distance to the parking space.

As described above, the target vehicle may receive the information on the empty parking space from the server or the preceding vehicle before it arrives at the destination to determine the final destination in which it is to be parked and may be attempted to be parked directly in the empty parking space without separately searching the empty parking space, such that a parking time may be shortened.

An operation flow of the apparatus for controlling parking of a vehicle according to the exemplary embodiment of the present disclosure configured as described above will be described below in detail.

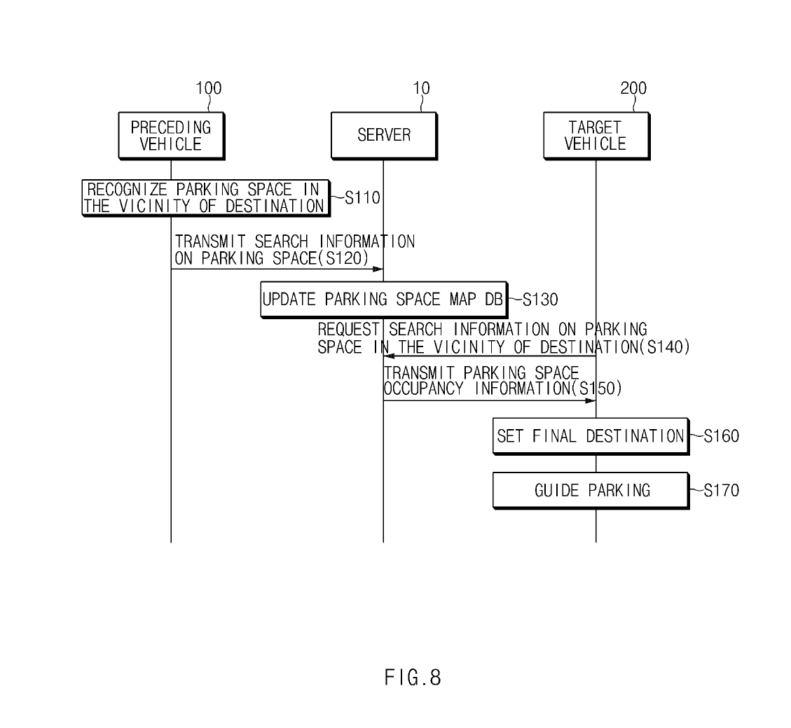

FIG. 8 illustrates a flow of operations of providing the information on the empty parking space from the server to the target vehicle.

Referring to FIG. 8, the preceding vehicle driven in the vicinity of the destination may recognize the parking space in the vicinity of the destination (S110), and transmit the search information on the recognized parking space to the server (S120).

Then, the server may update information on the empty parking space in the parking space map DB on the basis of the search information on the parking space provided from the preceding vehicle (S130).

In the case in which the target vehicle arrives at the defined distance from the point set to the destination, the target vehicle may request the server to transmit the search information on the parking space in the vicinity of the destination (S140).

The server may transmit parking space occupancy information at the corresponding position, for example, information on the empty parking space to the target vehicle in response to the request in ‘S140’ (S150). Here, the target vehicle may set the final destination on the basis of the information on the empty parking space received in ‘S150’ (S160), and guide parking on the basis of the set final destination (S170).

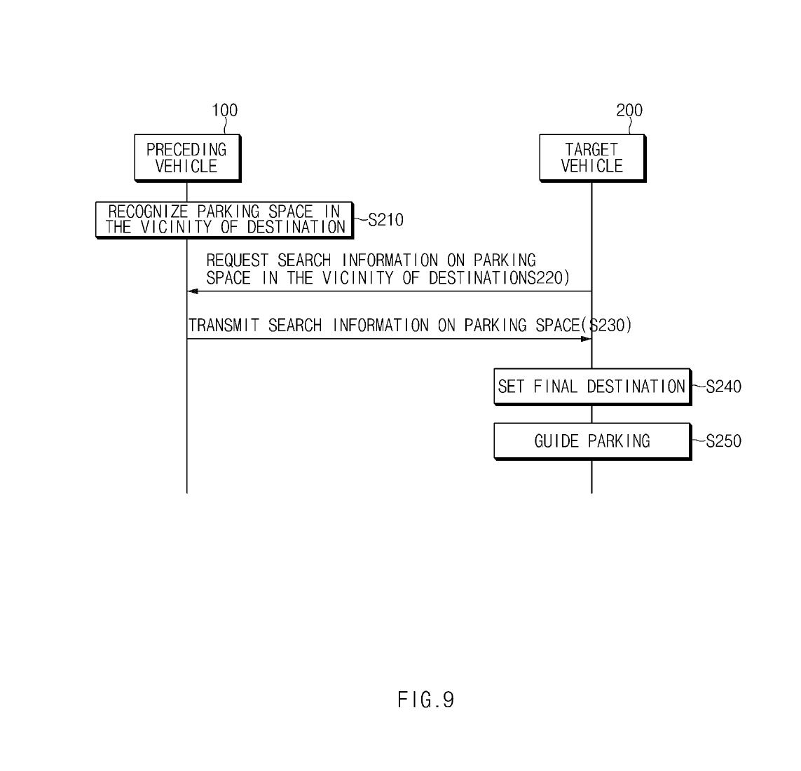

FIG. 9 illustrates a flow of operations of providing the information on the empty parking space from the preceding vehicle to the target vehicle.

Referring to FIG. 9, the preceding vehicle in the vicinity of the destination may recognize the parking space in the vicinity of the destination (S210), and store the search information on the recognized parking space therein.

In the case in which the target vehicle arrives in the defined distance from the point set to the destination, the target vehicle may request the preceding vehicle to transmit the search information on the parking space in the vicinity of the destination (S220).

The preceding vehicle may transmit parking space occupancy information at the corresponding position, for example, information on the empty parking space, to the target vehicle in response to the request in ‘S220’ (S230). Then, the target vehicle determines that the corresponding empty parking space is the final destination on the basis of the information received in ‘S230’ (S240), and performs parking guidance in relation to the determined final destination (S250).

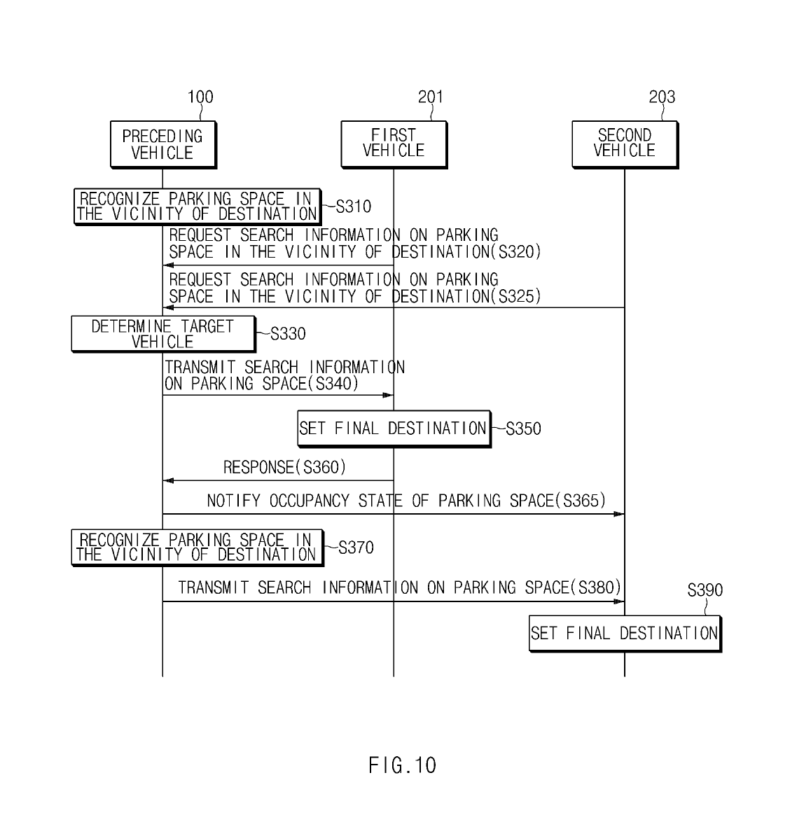

FIG. 10 illustrates a flow of operations of providing the information on the empty parking space from the preceding vehicle to a plurality of target vehicles.

Referring to FIG. 10, the preceding vehicle in the vicinity of the destination may recognize the parking space in the vicinity of the destination (S310), and store the search information on the recognized parking space therein.

Then, in the case in which first and second vehicles arrive in the defined distance from the point set to the destination, the first and second vehicles may request the preceding vehicle to transmit the search information on the parking space in the vicinity of the destination (S320 and S325).

The preceding vehicle may determine a target vehicle to which the search information on the parking space is to be preferentially provided, of the first and second vehicles in response to the requests in ‘S320’ and ‘S325’ (S330).

As an example, the preceding vehicle may determine that any one of the first and second vehicles is the target vehicle in consideration of distances between the first and second vehicles and the point set to the destination, destination arrival times, search information on the parking space set by the first and second vehicles, and the like.

In the case in which it is determined that the first vehicle is the target vehicle in ‘S330’, the preceding vehicle may transmit the search information on the parking space to the first vehicle determined to be the target vehicle (S340). The first vehicle may set the corresponding empty parking space to the final destination on the basis of the information received in ‘S340’ (S350).

Then, the first vehicle may transmit a response to the information received in ‘S340’ to the preceding vehicle (S360). Here, the first vehicle may transmit the occupancy determination information on the empty parking space set to the final destination as the response to the preceding vehicle.

The preceding vehicle may confirm an occupancy determination of the first vehicle for the empty parking space and then again recognize a parking space in the vicinity of the destination (S370), and transmit search information on the recognized parking space to the second vehicle (S380).

Likewise, the second vehicle may set the corresponding empty parking space to the final destination on the basis of the information received in ‘S380’ (S390).

The above-mentioned processes may be directly implemented by hardware or software module executed by a processor or a combination thereof. The software module may reside in a random access memory (RAM), a flash memory, a read only memory (ROM), an erasable programming ROM (EPROM), an electrically erasable programming ROM (EEPROM), a register, a hard disk, a detachable disk, a storage medium such as a compact disk-ROM (CD-ROM), that is, a memory and/or a storage. An illustrative storage medium may be coupled to a processor, which may read information from the storage medium and write information to the storage medium. As another method, the storage medium and the processor may also be formed integrally with each other. The processor and the storage medium may also reside in an application specific integrated circuit (ASIC).

As described above, according to exemplary embodiments of the present disclosure, the information on the empty parking space in the vicinity of the destination may be received in advance from the preceding vehicle driven in the vicinity of the destination, such that a time required for searching the parking position may be shortened.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling parking of a vehicle, comprising:
a destination setter for setting a destination required by a user and setting search information on a parking space in a vicinity of the set destination;
a controller for registering information on the empty parking space in the vicinity of the destination received from the outside when the vehicle arrives in a defined distance from the point set to the destination; and
a parking guider for performing parking guidance so that the registered empty parking space becomes a final destination.

2. The apparatus for controlling parking of a vehicle according to claim 1, wherein the information on the empty parking space in the vicinity of the destination is received from a preceding vehicle connected to the vehicle in a vehicle to vehicle (V2V) communication scheme and driven at the point set to the destination.

3. The apparatus for controlling parking of a vehicle according to claim 1, wherein the information on the empty parking space in the vicinity of the destination is received from a server connected in a vehicle to infrastructure (V2I) communication scheme and managing an occupancy state of the parking space.

4. The apparatus for controlling parking of a vehicle according to claim 3, wherein the information on the empty parking space in the vicinity of the destination is provided by the server registering occupancy state information on the parking space of the point set to the destination provided from one or more preceding vehicles driven at the point set as the destination.

5. The apparatus for controlling parking of a vehicle according to claim 1, wherein the information on the empty parking space in the vicinity of the destination is recognized at the front, the rear, the left, or the right of a point through which one or more preceding vehicles driven at the point set as the destination pass by sensors provided in the one or more preceding vehicles.

6. The apparatus for controlling parking of a vehicle according to claim 1, wherein the information on the empty parking space in the vicinity of the destination includes one or more of position information, path information, and reliability information on the corresponding empty parking space.

7. The apparatus for controlling parking of a vehicle according to claim 1, wherein the search information on the parking space in the vicinity of the destination includes at least one of whether or not the parking space in the vicinity of the destination is searched, a parking space search allowance distance, and parking space preferring information.

8. The apparatus for controlling parking of a vehicle according to claim 7, wherein the parking guider determines the final destination on the basis of preset parking space search information from among the registered empty parking spaces.

9. The apparatus for controlling parking of a vehicle according to claim 8, wherein the parking guider determines the final destination as other than the empty parking space on which occupancy notifying information is received when the occupancy notifying information on at least one of the registered empty parking spaces is received from the outside.

10. The apparatus for controlling parking of a vehicle according to claim 8, wherein the controller allows occupancy determination information on the corresponding empty parking space to be transmitted to the outside when the final destination is determined by the parking guider.

11. A method for controlling parking of a vehicle, comprising:
setting a destination required by a user and setting search information on a parking space in the vicinity of the set destination;
receiving information on an empty parking space in the vicinity of the destination from the outside when the vehicle arrives at a defined distance from a point set to the destination;
registering the received information on the empty parking space in the vicinity of the destination; and
performing parking guidance so that the registered empty parking space becomes a final destination.

12. The method for controlling parking of a vehicle according to claim 11, wherein in the step of receiving of the information on the empty parking space in the vicinity of the destination, the information on the empty parking space in the vicinity of the destination is received from a preceding vehicle connected in a V2V communication scheme and driven at the point set to the destination or a server connected in a V2I communication scheme and managing an occupancy state of the parking space.

13. The method for controlling parking of a vehicle according to claim 11, wherein the step of performing the parking guidance includes determining the final destination on the basis of preset parking space search information among the registered empty parking spaces.

14. The method for controlling parking of a vehicle according to claim 13, wherein in the step of determining of the final destination, the final destination is determined as other than the empty parking space on which occupancy notifying information is received when the occupancy notifying information on at least one of the registered empty parking spaces is received from the outside.

15. The method for controlling parking of a vehicle according to claim 13, wherein the method further includes:
transmitting occupancy determination information on the corresponding empty parking space to the outside when the final destination is determined.
